(19) United States
(12) Patent Application Publication
(10) Pub. No.: US 2017/0315937 A1
(43) Pub. Date: Nov. 2, 2017

(54) DATA STORAGE DEVICE WITH DYNAMIC DISPLAY

(71) Applicant: Lenovo (Singapore) Pte. Ltd., Singapore (SG)

(72) Inventors: Rod D. Waltermann, Rougemont, NC (US); Arnold S. Weksler, Raleigh, NC (US); John Carl Mese, Cary, NC (US); Nathan J. Peterson, Oxford, NC (US); Russell Speight VanBlon, Raleigh, NC (US)

(21) Appl. No.: 15/144,490

(22) Filed: May 2, 2016

(51) Int. Cl. G06F 13/10; H04W 4/00; G06F 3/0484; G09G 5/12

(52) U.S. Cl. CPC G06F 13/102; G09G 5/12; H04W 4/008; G06F 3/0484; G09G 2370/04; G09G 2330/023

(57) ABSTRACT

One embodiment provides a data storage device, including: a display; a processor operatively coupled to the display; and a memory device that stores instructions executable by the processor to: detect a trigger event associated with data stored on the data storage device; and update, based on the trigger event, the display. Other aspects are described and claimed.

### BACKGROUND

Users may use multiple information handling devices (e.g., personal computer, laptop, smart phone, tablet, etc.) to manipulate data. When the user wants to manipulate the same data on multiple devices, the user has to move the data from one device to another. For example, a user may email the file to himself or herself or store the file on a cloud storage device accessible by both devices. Another option that some users employ is the use of removable data storage devices (e.g., universal serial bus (USB) memory drives, external hard disk drives, secure digital (SD) memory card, removable media drives, etc.) that allow users to store data in a portable format. The user stores the data on the removable data storage device, and when the user wants to access the file from another device, the user can just connect the removable data storage device to the desired device.

### BRIEF SUMMARY

In summary, one aspect provides a data storage device, comprising: a display; a processor operatively coupled to the display; and a memory device that stores instructions executable by the processor to: detect a trigger event associated with data stored on the data storage device; and update, based on the trigger event, the display.

Another aspect provides a method, comprising: detecting, using a processor of a data storage device, a trigger event associated with data stored on the data storage device; and updating, based on the trigger event, a display of the data storage device.

A further aspect provides an information handling device, comprising: detecting, using a processor, a data storage device having a display; and providing, using a processor, a trigger event to the data storage device, wherein the trigger event causes the display of the data storage device to update.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIGS. 3A-3B illustrates example data storage devices with a display.

FIG. 4 illustrates an example method of dynamically updating a display of a data storage device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Many users store data on removable data storage devices (e.g., universal serial bus (USB) memory drives, external hard disk drives, secure digital (SD) memory card, removable media drives, etc.) due, in part, to the portability of the removable data storage device. The user only has to store the data (e.g., file, folders, images, documents, videos, music, etc.) on a single storage device and the data can be accessible from any information handling device that can connect to the removable data storage device.

However, removable data storage devices may not have as much data storage space as other storage devices, for example, hard disk drives of a desktop computer, remote data storage, and the like. Therefore, a user may have multiple removable data storage devices in order to store all the desired data. Additionally, even if the removable data storage devices have enough data storage space, a user may have multiple removable data storage devices in order to better organize the data or keep data separated. For example, a user may have one USB flash drive for work files and one for personal files. Thus, a user typically has many removable storage devices, some of which may look very similar.

The problem with all these storage devices is that users may find it difficult to remember which data is stored on which storage device. This may result in a user having to connect the removable data storage device to an information handling device to identify what data is stored on the storage device. Not only can this be tedious, but it is often time-consuming plugging in each storage device and waiting for the information handling device to read and display the data stored on the storage device. If that storage device does not have the desired data, then the user has to complete the same process with the other storage devices.

One solution for this problem is the user has to manually mark the storage device with an identifier. For example, a user may place a piece of colored tape around the storage device or may use a permanent writing utensil to write on the storage device. The problem with the colored tape or a similar approach is that the user still has to remember what each color is supposed to designate. In other words, the user still has to remember what color goes with what data. The problem with the permanent writing utensil is that the description has to be vague enough to correctly identify all the data that may be stored on the storage device. Additionally, if the user provides a marking that is more descriptive, then if the user changes the type of data stored on the storage device the marking may no longer be applicable. Since the marking is permanent, the user has to scratch it out. After several iterations of this, the user may no longer have a place on the storage device to mark.

These technical issues present problems for users trying to identify which storage device has the desired data. The current solutions either require the user to remember which storage device contains the data or manually mark the storage device to identify the storage device. If a user has many storage devices that all look similar, it may be impossible to tell which storage device has the desired data. The user then must perform the time-consuming and tedious process of connecting the storage devices to another device to read the data contained on the storage device.

Accordingly, an embodiment provides a data storage device having a dynamic display. The display may be updated based upon receipt of a trigger event. In one embodiment, the trigger event may include a manipulation of the data stored on the data storage device. For example, if a user accesses a file on the storage device, the display may be updated to present the name of that file. In one embodiment, the trigger event may include a manipulation to a characteristic associated with the data stored on the data storage device. For example, if a user connects the data storage device to an information handling device, the display may be updated to show the date and time of last access of the storage device.

In one embodiment, the data storage device may communicate with an information handling device using a short range communication device (e.g., near field communication device, Bluetooth® communication device, infrared communication device, radio communication device, etc.). The trigger event may then be produced by the information handling device. For example, a user may access a file structure on the information handling device and request a particular file. The file may be stored on a removable data storage device, as known by the information handling device. The information handling device may then send instructions to the particular data storage device to modify the display so that the user can identify which storage device has the desired file. An embodiment may also use the short range communication device to transmit data to the information handling device. For example, the data storage device may send the information handling device updates associated with the data stored on the storage device. BLUETOOTH is a registered trademark of Bluetooth Sig, Inc. in the United States and other countries.

The illustrated example embodiments will be best understood by reference to the figures. The following description is intended only by way of example, and simply illustrates certain example embodiments.

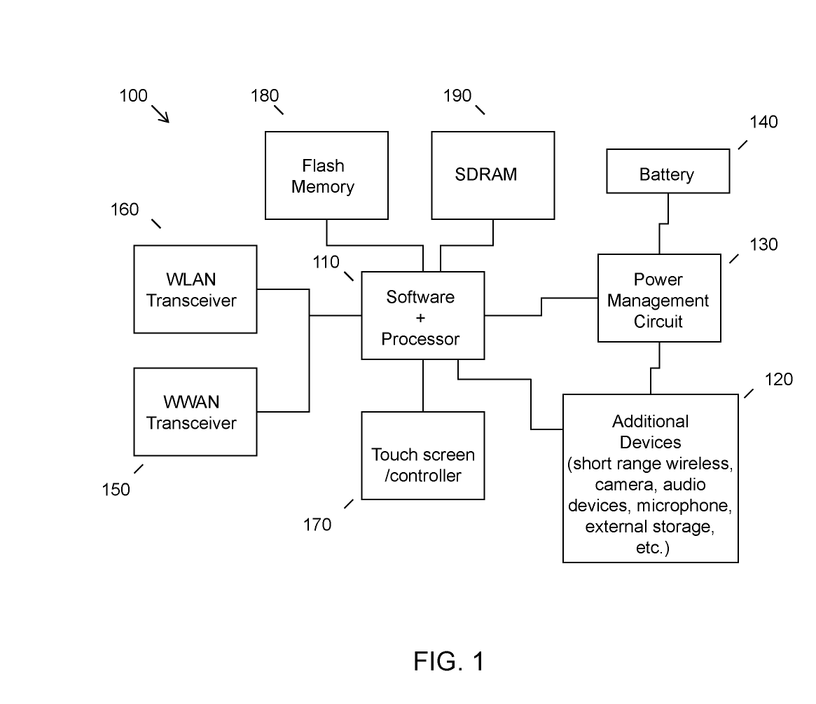

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., short range wireless communication devices, audio devices, etc. System 100 often includes a touch screen 170 for data input and display/rendering. System 100 also typically includes various memory devices, for example flash memory 180 and SDRAM 190.

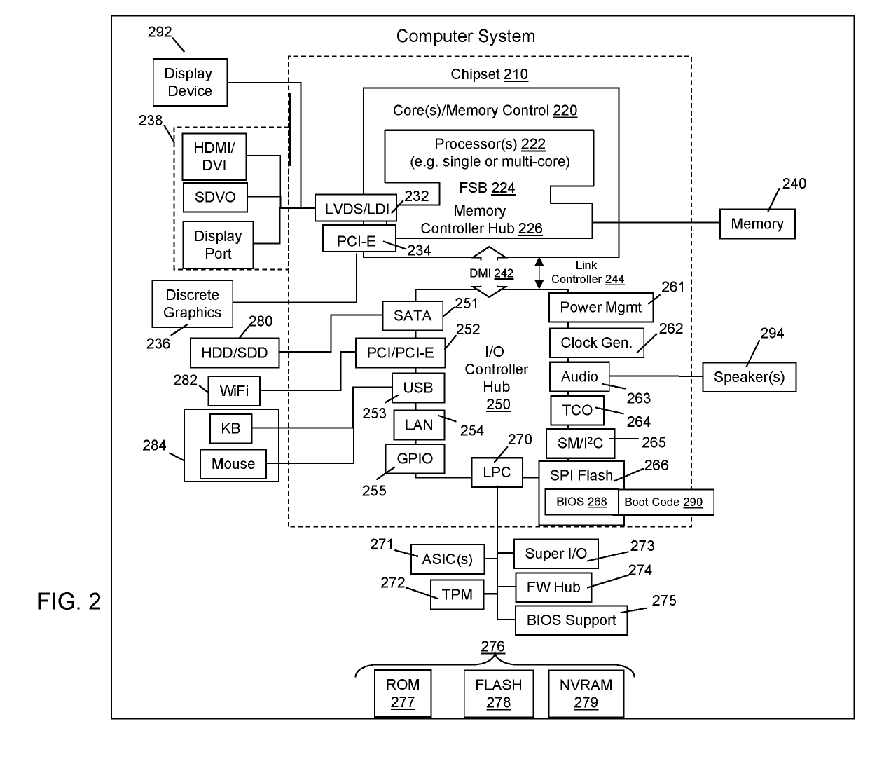

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which users may use to read and/or manipulate data stored on a data storage device. For example, the circuitry outlined in FIG. 1 may be implemented in a tablet or smart phone embodiment, whereas the circuitry outlined in FIG. 2 may be implemented in a personal computer embodiment.

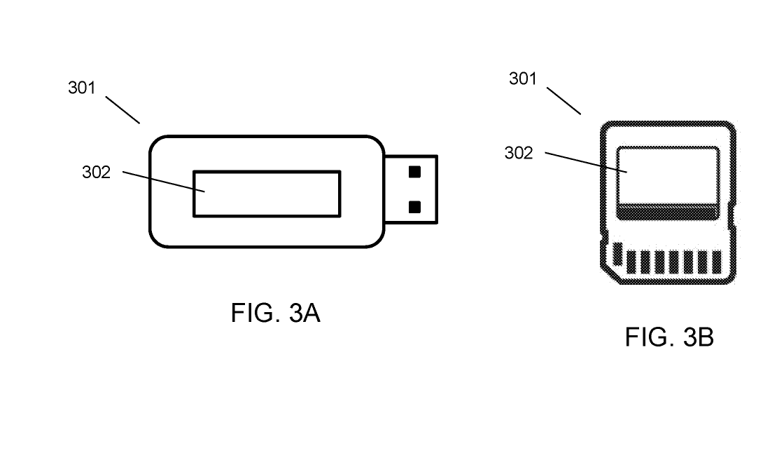

Referring to FIGS. 3A-B, an embodiment may include a data storage device 301. Examples of data storage devices may include a USB drive 301 in FIG. 3A, a hard disk drive, an SD memory card 301 in FIG. 3B, a removable media drive, and the like. In one embodiment the data storage device 301 may include a display 302. The display 302 may be any type of display, for example, a seven-segment display, liquid crystal display (LCD), light-emitting diode (LED) display, and the like. In one embodiment the display 302 may be a low power display, for example, an electronic paper display, an electronic ink display, a cholesteric liquid crystal display, a bistable display, and the like. An embodiment may additionally include a touch sensor, button, or other input device to allow scrolling between lines of text on the display.

The data storage device may or may not contain a power source depending on the type of display used. Additionally, the type of power source may differ based upon the display type. For example, a data storage device having a display with higher power requirements may require more or different power circuitry than a data storage device having a display with lower or no power requirements. The data storage device may additionally include a processor for interfacing with the display. The processor may have its own power requirements which may be fulfilled by the same power circuitry as the display or may be fulfilled by other power circuitry.

The display of the data storage device may display different characteristics of the data storage device. In one embodiment, the display may present the number of files or folders that are stored on the data storage device. The display may also present a graphical display. In one embodiment, the graphical display may include a graph showing the amount of storage space remaining, the division of files types, and the like. In one embodiment, the graphical display may be similar to a folder or file tree structure. The graphical display may also include the number of files or folders belonging to that type. For example, an embodiment may identify that four files are word processing files, five files are spreadsheet files, and two files are executable files. The information displayed on the display may include additional or alternative information, for example, the name of the last file accessed, the date and time of when the storage device was last accessed, how much storage space is remaining on the storage device, what information handling device last accessed the storage device, and the like.

The information presented on the display may be default or user configurable. In other words, the user may determine what information to be presented on the storage device. For example, the user may set the display to display the name of the last file or folder accessed. The user may also provide a description of the storage device. For example, for a SD card that the user uses for personal images, the user may change the display to “Home Pics.”

One embodiment may provide a description based upon the files or file names stored on the data storage device. For example, one embodiment may identify that all the files stored on the storage device are videos. An embodiment may then change the display to present the word “Videos.” An embodiment may also determine a description by categorizing the files or parsing the file names. For example, an embodiment may determine that all or a majority of the files include work-related names. An embodiment may then change the display to present the word “Work.”

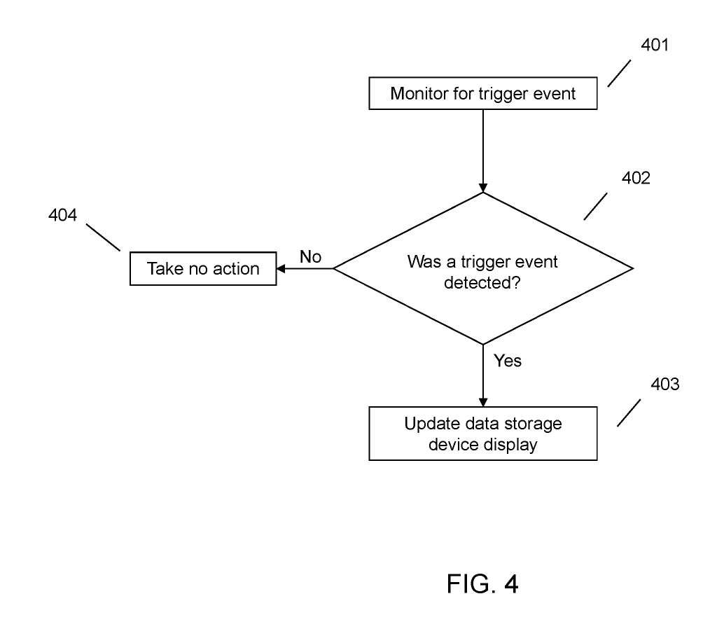

The data storage device may include a memory device storing instructions executable by the processor to modify the display based upon a trigger event. Referring to FIG. 4, an embodiment may monitor for a trigger event at 401. In one embodiment, the trigger event may include any event in which the data or a characteristic associated with the data was modified. For example, connecting the storage device to an information handling device may change the access date of the storage device or data on the storage device. A characteristic of the data may include metadata associated with the data or data storage device, for example, date of a last action, size of a file, name of the file, author of the file, location of the file, and the like. In one embodiment, the trigger event may include a manipulation of the data stored on the data storage device. Manipulation of the data may include modifying (e.g., moving, sending, overwriting, deleting, saving, etc.) the data, opening or accessing the data, and the like. The trigger event may also include connecting the storage device to an information handling device.

In one embodiment the data storage device may include a short range communication device for exchanging data with another device. For example, one embodiment may include a Bluetooth® communication device. Other forms of short range communication are contemplated and possible. For example, an embodiment may include a near field communication device, radio frequency communication device, infrared communication device, and the like. An embodiment may use the short range communication device to communicate with an information handling device. For example, an embodiment may use a Bluetooth® device to communicate with a personal computer. In one embodiment, the storage device may communicate details associated with the storage device to an information handling device using the short range communication device. For example, an embodiment may communicate the files stored on the storage device, the date of last access, a unique identifier associated with the storage device, and the like.

The trigger event may be provided by the information handling device using the short range communication device. In one embodiment the trigger event may include the information handling device sending instructions to the storage device. For example, the information handling device may send an identification request to the storage device. As another example, the instructions may include the information handling device accessing the storage device. The instructions may include a user sending an update to the storage device from an information handling device.

At 402, an embodiment may determine whether a trigger event associated with the data stored on the data storage device has been detected. If a trigger event is not detected at 402, an embodiment may take no action at 404. If, however, a trigger event is detected at 402, an embodiment may update the display of the storage device based upon the trigger event at 403. Updating the display may include updating the display to present updated information. For example, if the display is set to display the last accessed file, when a new file is accessed the display may be updated to display the new file that was last accessed. If the display is set to display the remaining storage space, when the amount of storage space changes, the display may update to display the new amount of storage space.

In one embodiment updating the display may include providing identification of the data storage device. As an example, a user may have multiple data storage devices. The data stored on the data storage devices may be stored or accessible by an information handling device. For example, the information handling device may include a manifest of the data stored on the storage devices. This manifest may include a hierarchical tree structure of the data, thumbnails of the data, short descriptions of the data, and the like. The information handling device may have a subset of the data on the storage device, but may not have the exact file saved to or accessible by the information handling device. In other words, the information handling device may have a preview of the data on the storage device, but may not access or modify the data. The information handling device may gather the preview information when the storage device is connected to the information handling device. Alternatively, the preview information may be contained on a remote storage location accessible by the information handling device, which may also be updated when the storage device is connected to any information handling device.

The user may then select the data they wish to access from the preview information displayed on the information handling device. The information handling device may know which data storage device the desired data is stored on. The information handling device may also identify whether the storage device is within range of the information handling device. For example, the data storage device may have transmitted information to the information handling device when the storage device is within range of the information handling device.

If the data storage device is within range, the information handling device may send an identification request to the data storage device to identify itself. The storage device may detect this trigger event and change the display in response to this identification request. For example, the storage device may change the display to display “The desired data is stored on this device.” Other examples of updating the display include the display changing colors, scrolling text, flashing, and the like. Thus, the user does not have to connect all the storage devices to the information handling device to identify which storage device contains the desired data.

The various embodiments described herein thus represent a technical improvement to current solutions of determining which removable data storage device contains the desired data. Using the techniques described herein, the user does not have to connect all the storage devices to the information handling device to find the desired data. Embodiments as described herein provide a data storage device having a dynamically updating display.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A data storage device, comprising:
a display displaying information corresponding to data stored on the data storage device;
a processor operatively coupled to the display; and
a memory device that stores instructions executable by the processor to:
detect a trigger event associated with data stored on the data storage device, wherein the trigger event is associated with accessing the data stored on the data storage device; and
update the display to display information associated with the data accessed on the data storage device.

2. The data storage device of claim 1, further comprising a short range communication device.

3. The data storage device of claim 2, wherein the instructions are further executable by the processor to communicate with an information handling device using the short range communication device.

4. The data storage device of claim 3, wherein the instructions executable by the processor to communicate comprise instructions executable by the processor to transmit details associated with the data storage device to the information handling device using the short range communication device.

5. The data storage device of claim 3, wherein the trigger event comprises receipt of instructions from the information handling device.

6. The data storage device of claim 5, wherein the receipt of instructions comprises receipt of an identification request from the information handling device.

7. The data storage device of claim 6, wherein the instructions executable by the processor to update the display comprise instructions executable by the processor to update the display to provide an identification of the data storage device based upon the identification request.

8. The data storage device of claim 1, wherein the trigger event comprises a modification to a characteristic associated with the data.

9. The data storage device of claim 1, wherein the trigger event comprises a manipulation of the data.

10. The data storage device of claim 9, wherein the manipulation of the data comprises a manipulation selected from the group consisting of: accessing the data and modifying the data.

11. The data storage device of claim 1, wherein the display comprises a low power display.

12. The data storage device of claim 1, wherein the trigger event comprises connection of the data storage device to an information handling device.

13. The data storage device of claim 1, wherein the data storage device comprises a device selected from the group consisting of: a universal serial bus drive, a hard disk drive, a secure digital memory card, and a removable media drive.

14. A method, comprising:
detecting, using a processor of a data storage device, a trigger event associated with data stored on the data storage device, wherein the trigger event is associated with accessing the data stored on the data storage device, wherein the data storage device comprises a display displaying information corresponding to data stored on the data storage device; and
updating, based on the trigger event, the display of the data storage device to display displays information associated with data accessed on the data storage device.

15. The method of claim 14, further comprising communicating, using a short range communication device, with an information handling device.

16. The method of claim 15, wherein the detecting a trigger event comprises receiving an identification request from the information handling device.

17. The method of claim 16, wherein the updating comprises changing the display to identify the data storage device based upon the identification request.

18. The method of claim 14, wherein the detecting a trigger event comprises detecting a modification to a characteristic associated with the data stored on the data storage device.

19. The method of claim 14, wherein the detecting a trigger event comprises detecting a manipulation to the data stored on the data storage device.

20. An information handling device, comprising:
a processor; and
a memory device that stores instructions executable by the processor to:
detect a data storage device having a display, wherein the display displays information corresponding to data stored on the data storage device; and
provide a trigger event to the data storage device, wherein the trigger event causes the display of the data storage device to update to display information associated with the data accessed on the data storage device, wherein the trigger event is associated with accessing the data stored on the data storage device.
